(19) United States
(12) Patent Application Publication
(10) Pub. No.: US 2021/0086913 A1
(43) Pub. Date: Mar. 25, 2021

(54) METHOD AND SYSTEM FOR HOUSING A DRONE FOR AUTONOMOUS LONG RANGE DRONE OPERATIONS

(71) Applicant: SkyX Limited, Woodbridge (CA)

(72) Inventors: Tzuki Friedman, Woodbridge (CA); Ariel Vander, Woodbridge (CA); Jason Braverman, Woodbridge (CA)

(21) Appl. No.: 17/025,093

(22) Filed: Sep. 18, 2020

Related U.S. Application Data
(60) Provisional application No. 62/902,617, filed on Sep. 19, 2019.

(51) Int. Cl. B64F 1/36; B64F 1/22; B64F 1/28; B60L 53/16; B60L 53/36; B60L 53/37; B25J 13/08; B25J 15/00; B25J 9/16

(52) U.S. Cl. CPC B64F 1/362; B64F 1/222; B64F 1/28; B60L 53/16; B60L 53/36; G01S 17/86; B25J 13/08; B25J 15/0066; B25J 9/1697; B60L 2200/10; B60L 53/37

(57) ABSTRACT

An autonomous drone system is provided. The autonomous drone system may comprise a drone station for automatically connecting a drone to the station for recharging. The automatic connection comprises determining a position of the drone on a platform of the station, rotating the platform based on the determined position, positioning an arm of the station in line with a connection port of the drone, and extending the arm towards the drone for connecting an end of the arm to the connection port of the drone.

### CROSS REFERENCE TO RELATED APPLICATIONS

The current application claims priority to U.S. Provisional application Ser. No. 62/902,617 filed Sep. 19, 2019, and entitled “Method for Housing A Drone For Autonomous Long Range Drone Operations,” the entire contents of which are hereby incorporated by reference in their entirety for all purposes.

### TECHNICAL FIELD

The current invention relates to the storage and autonomous flight control of a drone over long range, exceeding its normal flight envelope.

### BACKGROUND ART

Currently, there are few if any truly autonomous drone systems in operation. Most systems which claim to be fully autonomous, are in fact, partially autonomous, requiring human intervention to keep the drone operational. Additionally, there are few if any systems which can provide storage, recharging and maintenance of the drone during a mission profile, extending as far as the end user desires.

There is a need for drones which can operate very long range without the need for human intervention. Additionally, having such a system allows a great degree of flexibility for operators wanting to fly to locations normally out of reach for all but the largest drone systems, and all of those require complex human intervention to achieve such long range. For example, a normal drone, requires fuel of some sort, battery, gas, solar, combined with other factors, to create the max range the drone can fly. Once that energy is used up, the drone must land, refuel and be made ready for continuing the mission.

Accordingly, an additional, alternative, and/or improved autonomous drone system is desired.

### SUMMARY

In accordance with the present disclosure there is provided method of automatically connecting a drone to a station, the method comprising: determining a position of the drone in the station; rotating the drone, based on the determined position; positioning an arm of the station in line with a connection port of the drone; and extending the arm towards the drone for connecting an end of the arm to the connection port of the drone.

In accordance with the present disclosure, there is further provided an extendable arm of a drone station, the extendable arm comprising: a first end coupled to the station; and a second end being rotatably coupled to an end effector, the end effector comprising a charging port and a laser.

In accordance with the present disclosure, there is further provided a method of automatically positioning a drone in a station, the method comprising: moving an extendable arm along a wall of the station, an end of the extendable arm having a laser; determining a position of the drone via the laser of the extendable arm; and rotating the drone, based on the determined position, to align a connection port of the drone with a connection port of the station.

In accordance with the present disclosure, there is further provided a container for receiving a drone, the container comprising: a platform for receiving the drone; a laser located at an inside wall of the container, the laser determining a location of a connection port of the drone; and an extendable arm having a first end and a second end, the first end being coupled to the container, the second end being coupled to the connection port of the drone.

In accordance with the present disclosure there is provided a remote station for landing and storage of a drone, the station comprising: a housing structure having doors on a top surface to provide an open area sufficient to receive a drone; a platform comprising a landing area for receiving the drone and a mechanism for raising the landing area out of the housing through the open area of the doors and lowering the landing area into the housing through the open area of the doors; an imaging or ranging system within the housing to locate a connection port of the drone on the landing platform; and an extendable arm within the housing having a working end configured to connect to the connection port of the drone.

In a further embodiment the remote station, the platform further comprises a rotating mechanism capable of rotating the landing area with the drone.

In a further embodiment the remote station, the landing area is capable of being rotated to position the connection port of the drone at a location accessible to the working end of the extendable arm based on information from the imaging or ranging system.

In a further embodiment, remote station further comprises a gantry assembly within the housing.

In a further embodiment the remote station, the extendable arm is mounted on the gantry assembly.

In a further embodiment the remote station, the gantry assembly comprises two stages providing movement is orthogonal directions.

In a further embodiment the remote station, the imaging system comprises a laser range finder capable of scanning an area where the drone is present on the platform.

In a further embodiment, the remote station further comprises electronics and electrical systems within the housing.

In a further embodiment the remote station, the extendable arm comprises a plurality of working end components comprising one or more of: the imaging or ranging system; a battery charging connector capable of charging a battery; a multifuel charging connector capable of delivering a fuel comprising one or more of gasoline, diesel, and methanol; and a physical gripper for manipulating one or more components or parts on the drone; a dataport for connecting to a data exchange interface of the drone.

In a further embodiment, remote station further comprises additional imaging or ranging system components located on an interior of the housing.

In a further embodiment the remote station, the exterior dimensions have dimensions approximately equal to an inter-modal shipping container.

### BRIEF DESCRIPTION OF DRAWINGS

Further features and advantages of the present disclosure will become apparent from the following detailed description, taken in combination with the appended drawings, in which:

FIG. 1 depicts an embodiment of a drone station;

FIG. 2 depicts a landing platform of the drone station;

FIG. 3 depicts gantry assembly of the drone station;

FIG. 4 depicts an embodiment of a robotic attachment;

FIG. 5 depicts a robot end effector;

FIGS. 6A and 6B depict functionality of the robot end effector;

FIG. 7A depicts operation of a laser scanner; and

FIG. 7B depicts a rotated platform to correct alignment.

### DETAILED DESCRIPTION

The present invention provides an autonomous drone system including a drone station designed around a standard shipping container format. A shipping container, or inter-modal container, may be used as the housing for the station. Alternatively, the station may be constructed without the use of a shipping container but may still have dimensions corresponding to that of a standard shipping container. A standard shipping container may have a size of about 20 feet long or 40 feet long, although other sizes are possible. The width and height of the containers are typically about 8 feet and 8.5 feet respectively for both 20 and 40 foot containers. The container may be retrofitted with electrical equipment, computer equipment, a raisable platform, laser rangefinders, magnetic contact charging system, a gantry, moveable arm and other equipment for providing communications, security, thermal protection, and weather protection for the drone. The roof of the container may be specially designed to open similar to a door, allowing the drone to land on a raised platform of the container.

It will be appreciated that the container or station may accept drones from multiple vendors. This acceptance may be dependent on if the drone conforms to the specifications for communicating with and landing at the station or container. This allows the stations to be used for multiple drone types in the marketplace.

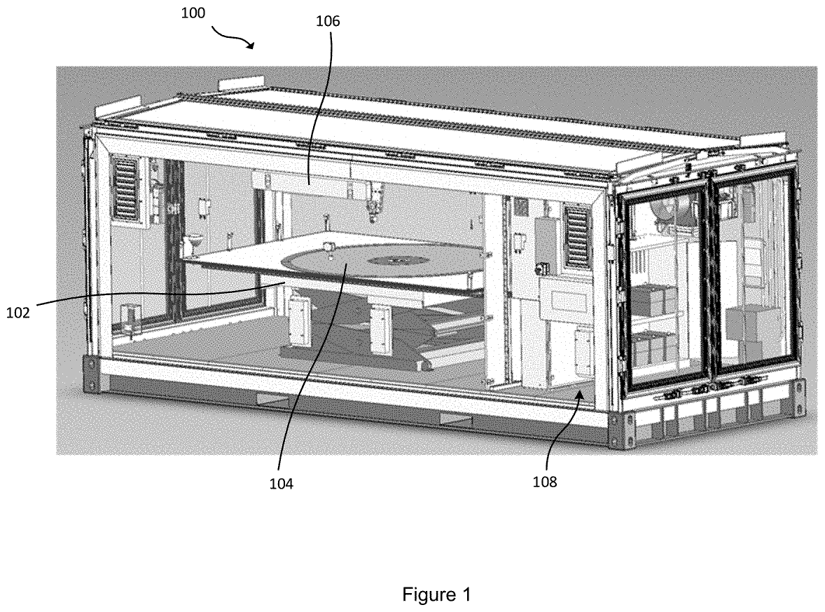

FIG. 1 depicts an embodiment of a drone station 100. The drone station 100 may comprise automation equipment, including a raising platform 102, a rotating landing area 104 on the platform 102, a two axis gantry 106, and various electronics and electrical systems. The electronics and electrical systems may be located in a control station area 108 of the station.

The drone station is a drone landing system that allows for a wide range of drones to land, recharge their fuel systems, and offload any data, as well as get protection from theft and potential weather conditions. The system may use a 20′ or 40′ foot shipping container or other suitable modular housing, where doors are created on the ceiling of the container allowing the top to open to receive the aircraft. The station may use a sort of virtual control tower that may run either in the cloud or on the premises. The control tower may control a remote “agent” software running at the drone stations themselves, which may inform the control tower of the current status of the station. This may include, if the station is occupied, charging, its doors are opening/closing, or a myriad of other variables, including localized weather information from a weather station that may be attached to the container or station. All of this information may be allocated and used to allow or disallow a drone from landing or taking off from the station(s). The control tower may have the ability to handle an unlimited number of stations and drones. The control tower may be limited only by the available computation power and communications bandwidth. It will be appreciated that a backend cloud solution may manage millions of concurrent drones/stations.

The drone station 100 may be connected to a backend cloud provider running the control tower which may gather the drone's data and post process it, or transmit it to the end user. It will be appreciated that it may be designed to traverse the station's network and allow the drone to transmit its data directly to the end user's own systems, or it may be designed to allow a human being to enter the control station side of the station or container and retrieve the data from a removable storage device, such as a USB drive.

A raisable platform 102 is located inside the interior space of the container, which raises and lowers to accept the aircraft or drone when landing. Upon receiving an electronic signal by varying methods, if the station 100 is available for a drone to land at, the station 100 will automatically open the ceiling doors and raise the platform 102 to accept the landing aircraft or drone. The platform 102 may have a rotating landing area located in the center, with electronic landing aids to assist the drone in locating the center of the landing area. Once the platform 102 has been raised to its maximum height, the landing aids may be turned on. Signals from the landing aids may be sent to the drone to aid the drone in triangulating its position in 3D space. The drone then uses the information to update its onboard autopilot to make corrections as needed to land in the center of the platform 102.

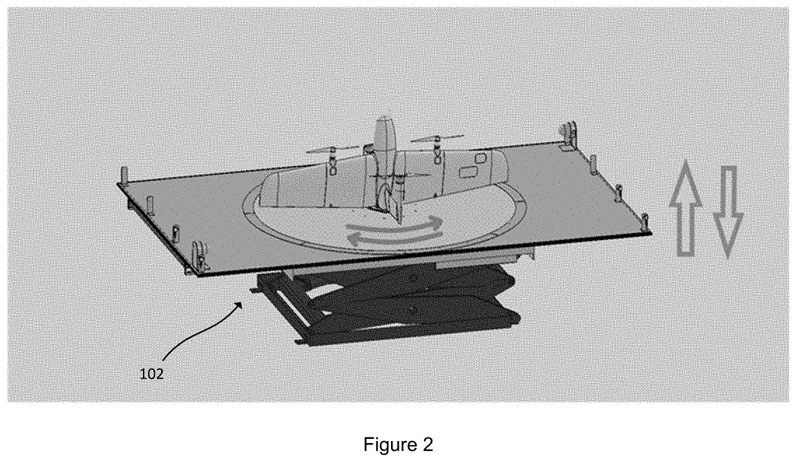

FIG. 2 depicts a landing platform 102 of the drone station. As described above, the platform 102 may be raised to receive the drone. Upon landing, the platform 102 may then descend into the structure and the ceiling doors of the station 100 will close. The platform 102 may be capable of two axis of movement. The platform 102 may move vertically, to lower the vehicle or drone into the station and to raise the vehicle or drone from the station. Further vertical movement may allow the drone to be at a correct height of the charging arm. The platform 102 may include a rotatable landing area to rotate the vehicle or drone to a correct orientation for the arm of the station 100 to align with the charging port on the vehicle or drone. The rotation may be done using a rotating landing area that may rotate 360 degrees to ensure the drone is always in a correct position to recharge. The rotation of the landing area may also be used to position the drone in a suitable orientation to be lowered into the station.

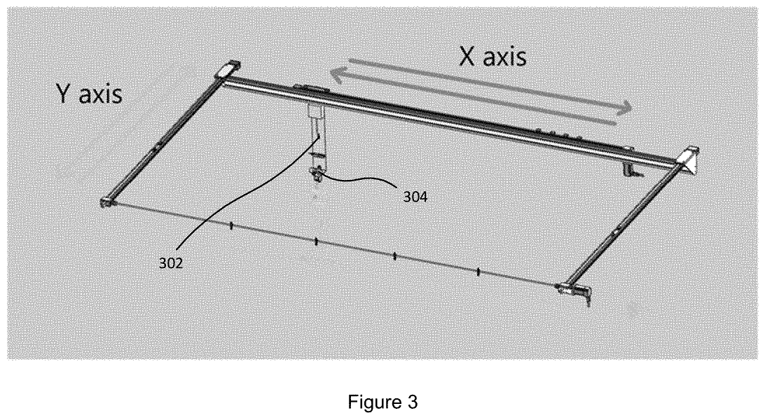

FIG. 3 depicts a gantry assembly of the drone station 100. The gantry may have two axis of freedom (X and Y) for movement. The movement may be realized through the use of linear rails, servo motors and rails, or other techniques. Although depicted as moving in both the X and Y axis, the gantry may only move along a single axis.

The gantry assembly may comprise an extendable arm 302 with an end effector 304 at an end of the extendable arm. The end effector 304 may comprise a laser rangefinder, imaging system or other positioning device, and a charging port. The motorized gantry system may comprise the laser rangefinder to determine the position of the drone and to locate the charging port of the drone. The extendable arm may be coupled to the X axis rail as shown in FIG. 3, so that the extendable arm may slide from one end of the container or station 100 to another. The extendable arm may extend parallel to the Y axis rail. Once the drone has landed on the platform, the platform may descend into the container space. At this time, a motorized gantry system can move along a long or a X axis of the container. A system of one or more lasers of the laser rangefinder will then beam onto the aircraft or drone from the platform 102 edge, and allow a local computer system to calculate the angle of the aircraft or drone in relation to the charging arm or gantry system. Once the angle of correction is determined, the rotating platform 102 may adjust the position of the aircraft so that the charging port on the aircraft or drone is aligned with the gantry charging arm located on a side wall of the container structure. The gantry arm may be positioned in a middle area of the X axis of the container wall before any extension for connecting to the drone. The gantry arm will then extend to the position where the charging port of the drone should be and will attach itself to the port using a magnetic connection. Once coupled, the charging process may begin and data may offloaded either via a wired connection (through the same connector as charging) or via wireless connection using WiFi methods.

The motorized gantry system may extend its arm in a direction parallel to the shorter or Y axis of the container, once the charging port of the drone has been located. The arm 302 may comprise a charging port on the end effector 304 for mating with the charging port of the drone. The charging port of the arm may be a magnetic charging port for the magnetic connection described above. When the arm extends towards the drone, the charging port of the arm can mate with the charging port of the aircraft or drone. It will be appreciated that if the charging port of the drone is not in an optimal position for mating with the arm, the platform may have the ability to rotate 360 degrees as well as raise or lower to maneuver the drone into a better position for mating with the charging system of the arm, as described above. A better position of the drone may be a position where the charging port of the drone is facing the charging port of the arm.

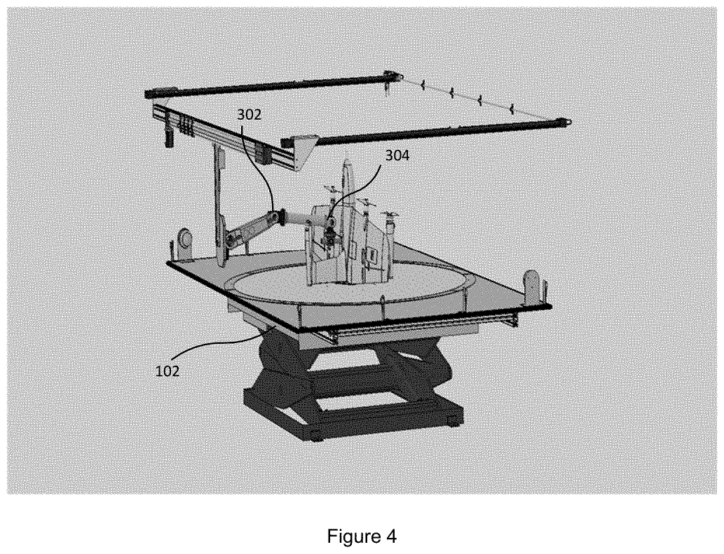

FIG. 4 depicts an embodiment of a robotic attachment of the gantry assembly. The robotic attachment may comprise the extendable arm 302 and end effector 304 or may connect or attach to the extendable arm 302. As depicted in FIG. 4, for the robotic attachment to connect or mate with the drone, the extendable arm 302 is in an extended position, with one end of the arm connected or mated to the drone.

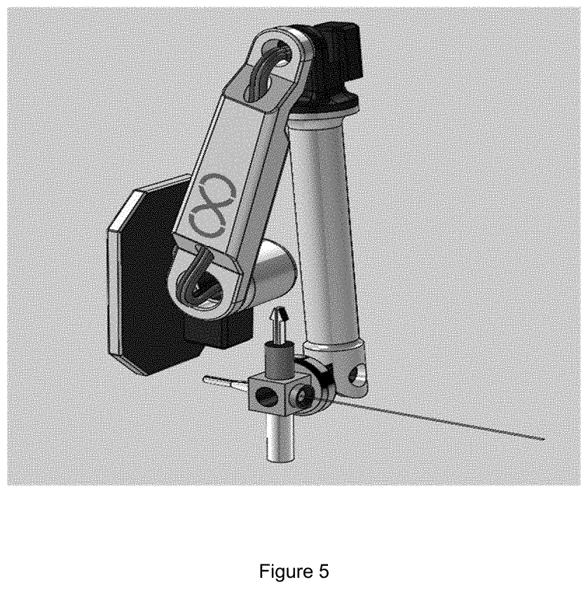

FIG. 5 depicts an embodiment of a robot end effector. The robot end effector may have 4 or more components including, for example: a rangefinder or imaging system, an electrical charging port, a multifuel charger, and a gripper capable of gripping or connecting to one or more of objects, mating attachments, and connection points. As described above, the laser may be used to locate a position of the drone or a component of the drone such as a charging port, and the charging port may be used to charge the drone. The charging system of the arm may also include a high speed data connection allowing the drone to offload its data or accept uploaded data as needed. The multifuel charger component may include gas, diesel, and/or methanol, which may be selected by a solenoid valve system at the stations fuel bladders. The gripper may be a mating attachment that can be connected to a fuel cell, battery, or payload to remove or load them from the drone. The mating attachments or connection points may also be used to reposition or move the drone, for example to reposition the drone on the landing area and or to move the drone to or from a storage area of the station..

Some power systems of the drone may include a battery, a hydrogen fuel cell or other systems as needed. In an embodiment, the station may use the robotic arm for changing the energy source for the drone if needed. In this case, the station or container may have a plurality of fueled energy sources. Should the drone require a replacement of the energy source, the system may automatically remove the existing or empty energy source, and place a fueled energy source inside the drone. The system may subsequently charge the empty energy source removed from the drone to reuse with a next drone. The subsequent charging of the empty energy source allows the source to be ready for the next drone that may require a fueled energy source.

Depending on the fuel type, the drone may remain in the drone station for a longer or shorter period. For example, for batteries, it would depend on the normal charge time of the battery being plugged into a standard charging system. For gas fuel, the drone would not remain in the station for very long as the refueling would be quite fast. For a hydrogen fuel cell, it would depend on whether or not the fuel canister need replacing or if the canister or cylinder may be refueled with more gas. Refueling the canister or cylinder may take longer depending on the size.

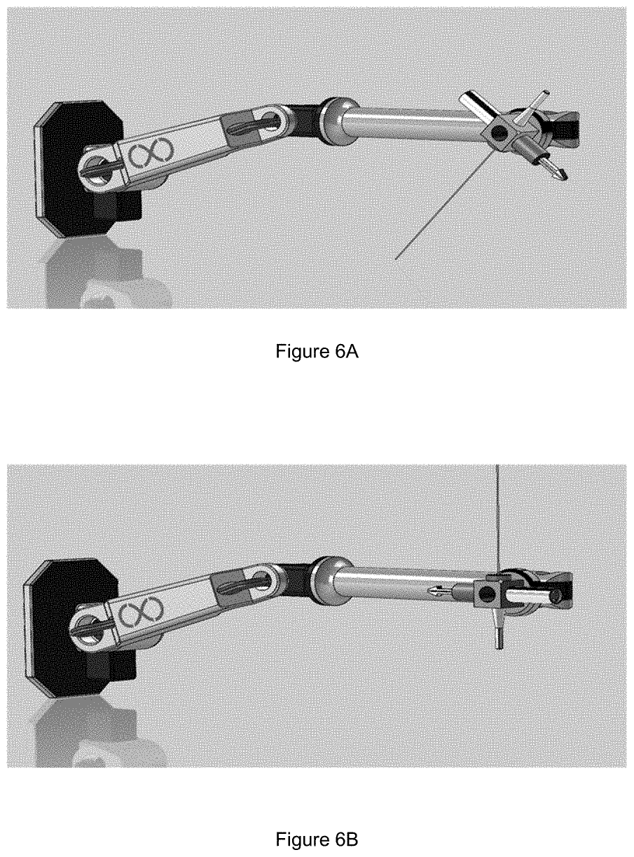

FIGS. 6A and 6B depict functionality of the robot end effector of FIG. 5. As described above and depicted in FIGS. 6A and 6B, the extendable arm may extend towards a drone. The end effector may be rotatably connected to the extendable arm so that the end effector can rotate before coupling to the drone. This allows the required aggregate to be properly positioned for connection with the drone. For example, as depicted in FIG. 6B, the end effector is rotated so that the electric charging port is facing the drone. By rotating the axis of the end effector, the different functions of the aggregates may be selected, allowing the system to perform the different tasks for the drones.

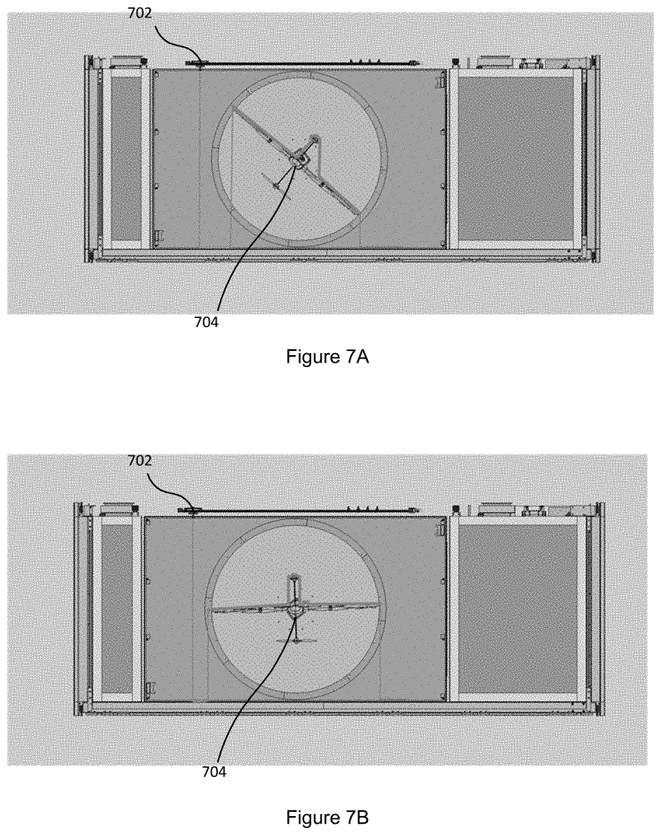

FIG. 7A depicts operation of a laser scanner 702. As described above, the laser scanner 702 may be used to identify a position of the drone 704 or vehicle once it has landed on the platform. The position of the drone 704 is determined so that the drone 704 may be oriented for the alignment of extendable arm on the station with charging port of the drone. As depicted in FIG. 7A, the laser 702 may scan the drone 704 or vehicle in a sweeping motion, from one end of the platform or side of the container to the other end. This may allow the laser 702 to identify an angle of vehicle or drone 704, and to calculate an error of the scanned contour of the drone 704 from a predetermined ideal alignment contour. The system may then use a rotational axis of the landing platform to correct any misalignment of the drone 704 or vehicle after landing, based on the scanned contour.

FIG. 7B depicts a rotated platform to correct alignment. As shown in FIG. 7B, the platform has rotated sufficiently from its position in FIG. 7A to a better alignment orientation. The laser scanning and calculation of alignment error allows the system to automatically rotate the platform to better align the charging port of the drone 704 with the end effector of the extendable arm. The better alignment may be understood to be a correct alignment orientation.

The sweeping of the laser 702 across the side of the container or platform allows an exact location of the charging port of the drone 704 to be determined.

As described above, the container or station housing may provide everything that the drone may need to recharge or replace its energy systems to take off again and continue its flight. It will be appreciated that the drone's normal flight envelope may be extended by placing multiple stations or containers along a desired flight route of the drone. This may allow an operator to achieve as far a distance as they wish, being limited only by the availability of ground stations or containers.

The drone station may accommodate any variety of refueling from, for example, batteries, gas, or hydrogen fuel cells. The drone station may allow the drone to be protected during charging as the station is robust to prevent theft and weather elements. The drone station has room for additional systems like post processing computers, replacement parts, etc. This allows the station to be a more complete solution for long range systems (while also allowing short range systems to land and recharge/offload data if needed as well).

It will be apparent to persons skilled in the art that a number of variations and modifications can be made without departing from the scope of the invention. Although specific embodiments are described herein, it will be appreciated that modifications may be made to the embodiments without departing from the scope of the current teachings. Accordingly, the scope of the invention should not be limited by the specific embodiments set forth, but should be given the broadest interpretation consistent with the teachings of the description as a whole.

What is claimed is:

1. A remote station for landing and storage of a drone, the station comprising:
a housing structure having doors on a top surface to provide an open area sufficient to receive a drone;
a platform comprising a landing area for receiving the drone and a mechanism for raising the landing area out of the housing through the open area of the doors and lowering the landing area into the housing through the open area of the doors;
an imaging or ranging system within the housing to locate a connection port of the drone on the landing platform; and
an extendable arm within the housing having a working end configured to connect to the connection port of the drone.

2. The remote station of claim 1, wherein the platform further comprises a rotating mechanism capable of rotating the landing area with the drone.

3. The remote station of claim 2, wherein the landing area is capable of being rotated to position the connection port of the drone at a location accessible to the working end of the extendable arm based on information from the imaging or ranging system.

4. The remote station of claim 1, further comprising a gantry assembly within the housing.

5. The remote station of claim 3, wherein the extendable arm is mounted on the gantry assembly.

6. The remote station of claim 4, wherein the gantry assembly comprises two stages providing movement is orthogonal directions.

7. The remote station of claim 1, wherein the imaging system comprises a laser range finder capable of scanning an area where the drone is present on the platform.

8. The remote station of claim 1, further comprising electronics and electrical systems within the housing.

9. The remote station of claim 1, wherein the extendable arm comprises a plurality of working end components comprising one or more of:
the imaging or ranging system;
a battery charging connector capable of charging a battery;
a multifuel charging connector capable of delivering a fuel comprising one or more of gasoline, diesel, and methanol; and
a physical gripper for manipulating one or more components or parts on the drone;
a dataport for connecting to a data exchange interface of the drone.

10. The remote station of claim 9, further comprising additional imaging or ranging system components located on an interior of the housing.

11. The remote station of claim 1, wherein the exterior dimensions have dimensions approximately equal to an inter-modal shipping container.
